(19) United States
(12) Patent Application Publication
(10) Pub. No.: US 2008/0140649 A1
(43) Pub. Date: Jun. 12, 2008

(54) Methods for providing suggestive results

(76) Inventor: Frank John Williams, Los Alamitos, CA (US)

Correspondence Address: Frank John Williams, 2711 Saint Albans Dr., Los Alamitos, CA, 90720, US

(21) Appl. No.: 11/998,019

(22) Filed: Nov. 27, 2007

Related U.S. Application Data
(60) Provisional application No. 60/861,169, filed on Nov. 27, 2006.

(51) Int. Cl. G06F 17/30

(52) U.S. Cl. 707/5

(57) ABSTRACT

A series of methods and systems for searching, providing, displaying and suggesting results of records comprising the conversion, transformation and/or mathematical operation of values and quantities are described. In one embodiment, values identifying words and/or quantities in a query are mathematically operated thus suggesting and enabling the retrieval of other similar or proximal values ultimately identifying suggestive information.

### RELATED APPLICATIONS

This patent application claims the benefit of U.S. provisional patent application Ser. No. 60/861,169 filed 2006 Nov. 27 by the present inventor.

### BACKGROUND

1. Field of the Invention

The present invention relates generally to several methods for retrieving and providing information in general. More particularly, to a method for searching, retrieving, providing, and displaying results which are similar but not identical to the query.

2. Description of Related Art

The Search Engine is one the most important and valuable tools the Internet offers to its users, allowing them to quickly find important and relevant information. However, current search technology is incapable of finding similar or almost identical information to the query. In order to successfully retrieve information, the user must enter the exact information in the query and/or request the proper search engine behavior such as requesting the retrieval of synonyms to find similar information to what was entered in the query. Nevertheless, the retrieval of values and quantities in particular is quickly undermined if the information entered does not precisely match the current values in the inventories. As a result, the user must faced the uncertainty of entering a particular amount such as $500.00 to retrieve a specific item and consequentially fail to retrieve or find any other items similarly priced such as $499.99 which would have clearly satisfy the user's request, budget, and necessities.

### SUMMARY OF THE INVENTION

The present invention teaches certain benefits in use and construction which give rise to the objectives and advantages described below. The methods embodied by the present invention overcome the limitations and shortcomings encountered when querying information does not match or is not found in the source of information, thus failing to retrieve other similar and comparable data which could potentially satisfy the user's query. The present invention discloses a series of methods for at least one of a: searching, retrieving, displaying, providing, and suggesting other likely and analogous information from a query.

### OBJECTS AND ADVANTAGES

A primary objective inherent in the above described method of use is to provide a means and methods for searching, retrieving, displaying and/or suggesting information not taught by the prior arts and further advantages and objectives not taught by the prior art. Accordingly, several objects and advantages of the invention are

Another objective is to find similar and analogous information which was not requested in a query.

Another objective is to save user's time by quickly and automatically finding similar information.

Another objective is to aid information providers, websites and ecommerce to provide valuable and comparable information.

Another objective is to find similar information regardless of the user's skill and knowledge.

A further objective is to allow a search engine the means to provide control to retrieve similar information.

A further objective is to deal with equally valuable information in equal manner.

A further objective is to enhance ecommerce.

A further objective is to permit detailed querying with some level of flexibility.

A further objective is to avoid irrelevance by permitting flexible detailed querying without any degree of flexibility.

Other features and advantages of the described methods of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate at least one of the best mode embodiments of the present method of use. In such drawings:

FIG. 1 is a non-limiting block diagram of the main steps of the inventive method.

FIG. 2A and FIG. 2B are non-limiting exemplary illustrations of the inventive method implementing the search methodology of eeggi or “Engineered Encyclopedic Grammatical and Global Identities” for generating a value range of a price of an item is a query;

FIG. 3 is another non-limiting exemplary illustration of the inventive method implementing the search methodology of eeggi for retrieving words in addition to currency and/or quantities;

FIG. 4 is a non-limiting exemplary illustration of several slight variations of the inventive method implementing text-based technology while dealing with currency;

FIG. 5 is another non-limiting exemplary illustration of a slight variation of the inventive method implementing text-based technology;

FIG. 6 is non-limiting exemplary illustration of a variation of the inventive method providing a series of echelon suggestions.

### DETAILED DESCRIPTION

The above described drawing figures illustrate the described methods and use in at least one of its preferred, best mode embodiment, which is further defined in detail in the following description. Those having ordinary skill in the art may be able to make alterations and modifications what is described herein without departing from its main spirit and scope. Therefore, it must be understood that what is illustrated is set forth only for the purposes of example and that it should not be taken as a limitation in the scope of the present system and method of use.

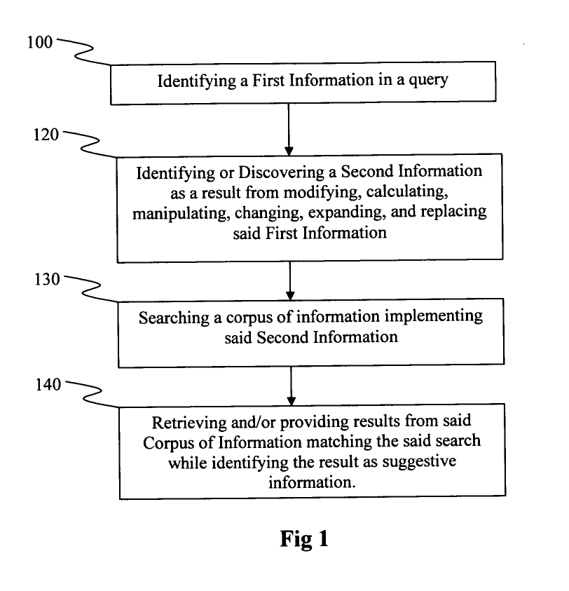

FIG. 1 is a non-limiting block diagram of the main steps of the inventive method. The First Step 100 (FIG. 1) involves identifying a First Information in a query, such as identifying the word or value $500.00 in a query. The second step 120 (FIG. 1) involves identifying or discovering a Second Information resulting from performing an altering action of said First Information including at least one of a: modifying, expanding, replacing, and calculating. For example, the entered $500.00 value from the First Step is added $20, thus forming a value range from $500 to $520. The Third Step 130 (FIG. 1) involves searching a Corpus of Information implementing said Second Information. For example, searching for information implementing the said newly formed value range defined between the values of $500 and $520. The Fourth and final Step 140 (FIG. 1) involves providing the results from said search, identifying the results as suggestive information. For example, the search retrieves a record comprising the value of $517.00 and displays it in a suggestions window/section.

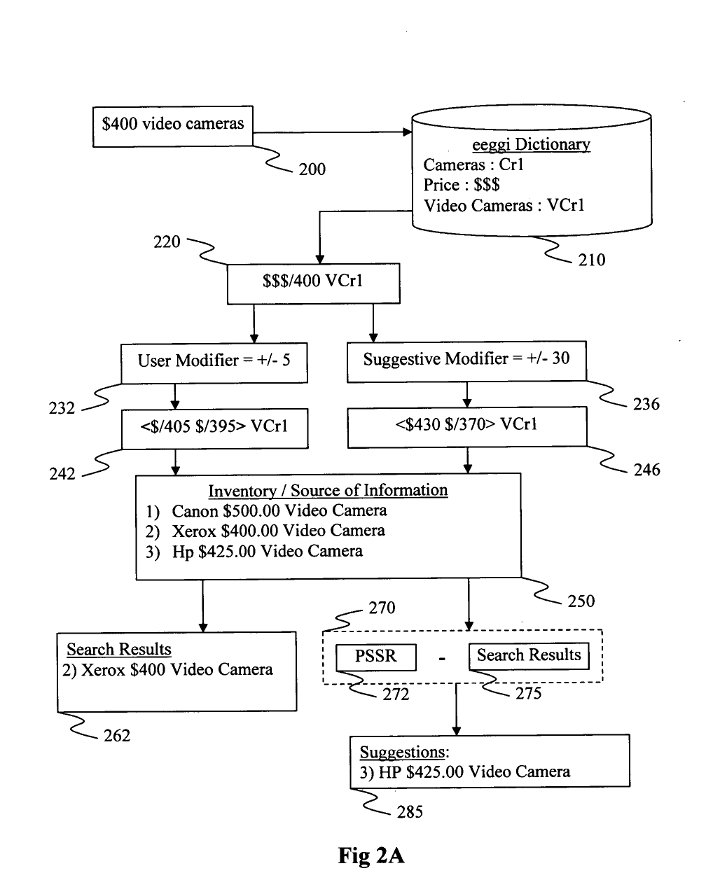

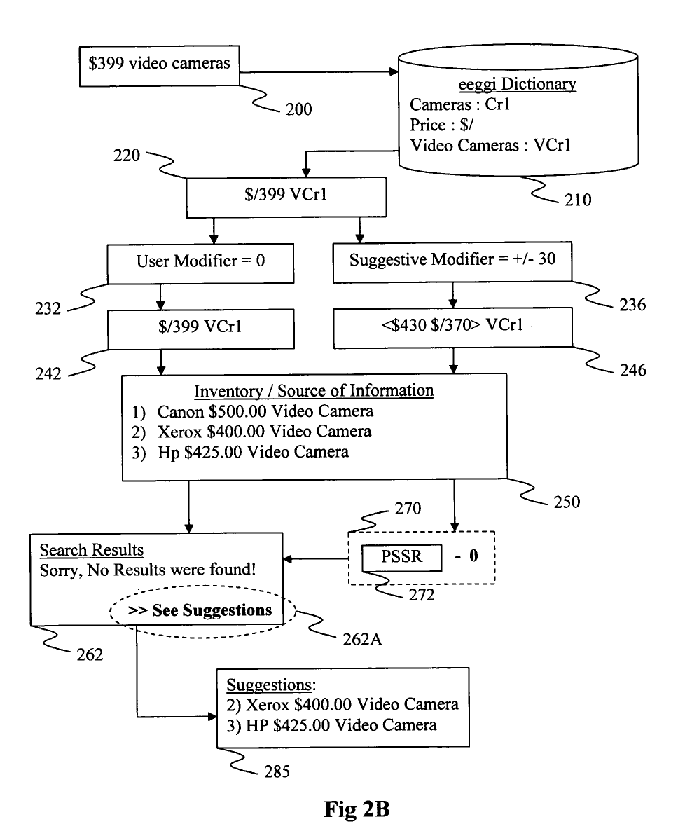

FIG. 2A and FIG. 2B are non-limiting exemplary illustrations of the inventive method implementing the search methodology of eeggi or “Engineered Encyclopedic Grammatical and Global Identities” for generating a value range of a price of an item is a query. The methodology of eeggi implements a “numeric modifier” that the user has access to for expanding and/or modifying the elements of search. However, if the numeric modifier is insufficient, the search may fail to retrieve results. In such fashion, the Initial Query 200 (FIG. 2A) is modified and/or converted into the eeggi Query 220 (FIG. 2A) implementing the eeggi Dictionary 210 (FIG. 2A). The User Modifier 232 (FIG. 2A) modifies the eeggi Query into the User Range Query 242 (FIG. 2A) that searches the Source of Information or Inventory 250 (FIG. 2A) retrieving the Results 262 (FIG. 2A). On the other hand, the eeggi Query 220 (FIG. 2A) is also modified by the Suggestive Modifier 236 (FIG. 2A) thus forming the Suggestive Range Query 246 (FIG. 2A) that also searches the Inventory 250 (FIG. 2A) retrieving the Search 2 Results 272 (FIG. 2A). Then the Subtracting Calculation 270 (FIG. 2A) subtracts the Search Results 275 (FIG. 2A) from the Pre-Suggested Searched Results 272 (FIG. 2A) or “PSSR” for short, thus providing the Suggestive Results Display 285 (FIG. 2A). Please note, in the event that the Subtracting Calculation equals zero (SSR−Search Results=0) no Suggestive results will be generated thus removing the need of providing any information identifying any suggestions and/or Suggestive Result. FIG. 2B illustrates a non-limiting similar scenario that the one depicted in FIG. 2A, but this time the User Modifier is zero (user desires no synonyms and/or similarities). The Initial Query 200 (FIG. 2B) is modified and/or converted into the eeggi Query 220 (FIG. 2B) implementing the eeggi Dictionary 210 (FIG. 2B). As illustrated, the User Modifier 232 (FIG. 2B) equal zero, thus adding and/or subtracting nothing to the eeggi Query 220 (FIG. 2B) which is this example gets copied and/or re-illustrated and renamed as the User Range Query 242 (FIG. 2B) which searches the Inventory 250 (FIG. 2B) failing to find or retrieve any records as illustrated by the Search Results 262 (FIG. 2B). Meanwhile, the eeggi Query 220 (FIG. 2B) is modified by the Suggestive Modifier 236 (FIG. 2B) to which the user has no access, thus forming the Suggestive Range Query 246 (FIG. 2B) that it is also used to search the Inventory 250 (FIG. 2B) therefore retrieving the PSSR 272 (FIG. 2B). Due to the fact that no records were retrieved or displayed in the Search Results 262 (FIG. 2B), in this example, the Subtracting Calculation 270 (FIG. 2B) involves subtracting zero which would not affect any records in the SSR; or simply the Subtracting Calculation is ignored. In addition, the absence of records in the Search Results 262 (FIG. 2B) is accountable for generating the “See Suggestions” link 262A (FIG. 2B) which is responsible for displaying the Suggestion Results 285 (FIG. 2B) providing the two sampling records (Xerox $400.00 Video Camera, and HP $425 Video Camera).

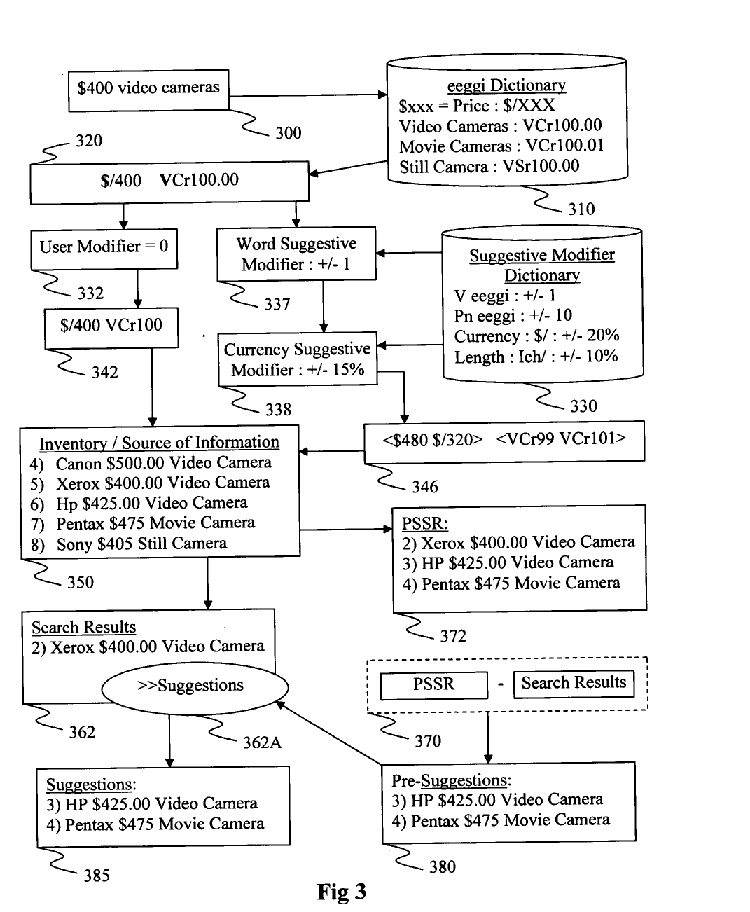

FIG. 3 is another non-limiting exemplary illustration of the inventive method implementing the search methodology of eeggi for retrieving words in addition to currency and/or quantities. In the eeggi technology, all words are fully or partially identify through a value(s). Accordingly, when suggestive values are generated, it is important to keep in mind the numeric spectrums that the user requests, and the numeric spectrums that are generated due to the suggestive modifiers as depicted by previous figures. Consequentially, it is preferable to implement suggestive modifiers that are specifically tuned or designed to deal with words (suggestive word modifiers), while other suggestive modifiers are designed to deal specifically with currency and numbers (suggestive currency modifiers, and suggestive number modifiers). In such fashion, the disclosed inventive method can provide superior search accuracy, and several new available user controls and features. For example, the Initial Query 300 (FIG. 3) is converted into the eeggi Query 320 (FIG. 3) implementing the eeggi Dictionary 310 (FIG. 3). As illustrated, the User Modifier 332 (FIG. 3) is zero, therefore the eeggi Query is simply repeated to facilitated this illustration into the Repeated eeggi Query 342 (FIG. 3), which searches the Inventory 350 (FIG. 3) and retrieves only but one record (Xerox $400.00 Video Cameras) as depicted in the Search Results 362 (FIG. 3). However, the eeggi Query 320 (FIG. 3) was simultaneously searched in the Suggestive Modifier Dictionary 330 (FIG. 3) for identifying specific modifiers that would be affecting every (or most) eeggi element in the eeggi Query in a particular manner, quantity or format. As illustrated in the Suggestive Modifier Dictionary 330 (FIG. 3), all “V” eeggis get suggestively modified by the quantity of “1” (+/−1); while the “Pn” eeggis will get suggestively modified by the quantity of “10” (+/−10). In similar fashion, the Suggestive Modifier Dictionary 330 (FIG. 3) depicts that any currency value in the eeggi Query 320 (FIG. 3) will be suggestively modified by 20% (+/−20%). Accordingly, each word eeggi is influenced by its respective word modifier, and every currency eeggi is affected by the “+/−20%” modifier. As a result, the eeggi Query 320 (FIG. 3) is replaced with the Specific Suggested eeggi Query 346 (FIG. 3) or “SSEQ” for short, which as illustrated contains two different eeggi spectrums, such as “<$480 $320>” or any value smaller than $480 and bigger than $320, and “<VCr101 VCr99>” or any value smaller than VCr101 and bigger than VCr99. Accordingly, the SSEQ 346 (FIG. 3) searches the Inventory 350 (FIG. 3), retrieving the Pre-Suggestive Search Results 372 (FIG. 3) or “PSSR” for short. Please note in the Inventory 350 (FIG. 3), how only three records (second, third and fourth) match the Query 346 (FIG. 3) and the other two records (first and fifth) do not match because of the “$500” amount, and the “Still Camera” word/eeggi respectively. Accordingly, the Subtraction Calculation 370 (FIG. 3) subtracts the Search Results from the PSSR, resulting in the Pre-Suggestive Display 380 (FIG. 3). Consequentially, the Suggestion Button 362A (FIG. 3) is displayed which when clicked, leads to the Suggestions Display 385 (FIG. 3) which in this example is nothing else than a copy of the Pre-Suggestive Display 380 (FIG. 3).

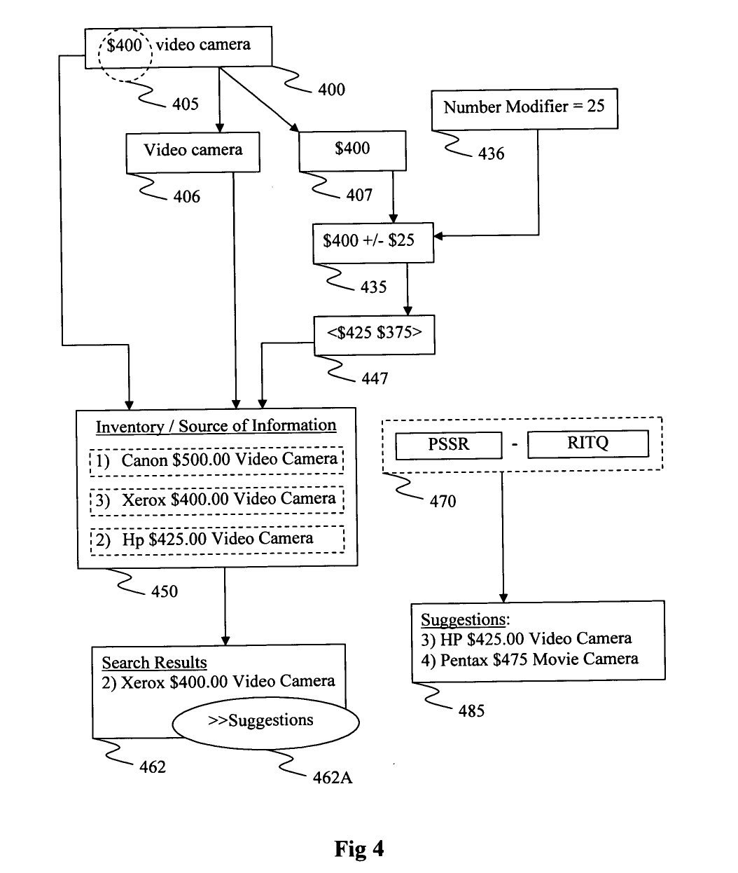

FIG. 4 is a non-limiting exemplary illustration of several slight variations of the inventive method implementing text-based technology while dealing with currency. With many resemblances, equivalent steps, more detailed steps, and additional steps to the examples of the methods depicted in the previous figures, the text-based methodology makes use of the inventive method by identifying any values and/or currency in the query. For example, the Initial Text Query 400 (FIG. 4) or “ITQ” for short, is distilled, examined and/or investigated with the purpose of finding a number such as the Existent Number 405 (FIG. 4) or “$400.00.” Consequentially, the ITQ is divided into two Queries such as the Second Text Query 406 (FIG. 4) and the Number Query 407 (FIG. 7). Accordingly, the Calculation 435 (FIG. 4) makes use of the information of the Number Query 407 (FIG. 7) and the Number Modifier 436 (FIG. 4) or “+/−$25.00” for calculating (adding and subtracting) the New Modified Number Spectrum Query 447 (FIG. 4) or “NMNSQ” for short. Please note how the NMNSQ involves the numeric spectrum search of only those quantities “bigger” than $375 and lesser than $425. Consequentially, in the next step, the Source of Information or Inventory 450 (FIG. 4) is searched implementing both, the Second Text Query 406 (FIG. 4) and the NMNSQ 447 (FIG. 4). As illustrated, the Inventory 450 (FIG. 4) contains three records from which only the First Record 451 (FIG. 4) contains all the matching text elements from the Second Text Query 406 (FIG. 4) and the numeric elements of the NMNSQ 447 (FIG. 4). As a result, the Subtraction Calculation 470 (FIG. 4) distills or separates the records generated by the ITQ 400 (FIG. 4) from those found by both suggestive queries or Second Text Query 406 (FIG. 4) and NMNSQ 447 (FIG. 4). Consequentially, when the Suggestion Button 462A (FIG. 4) is clicked, the Suggest Records Window 485 (FIG. 4) is generated displaying the said First Record resulting from the NMNSQ and Second Text Query. Please note, the ITQ 400 (FIG. 4), which was responsible for generating the matching Search Results 462 (FIG. 4), is not illustrated in an effort to keep the present disclosure simple while avoiding the disclosure of prior art. Please note how in this example, the Suggestion Link 462A (FIG. 4) is displayed regardless of the ITQ 400 (FIG. 4) outcome.

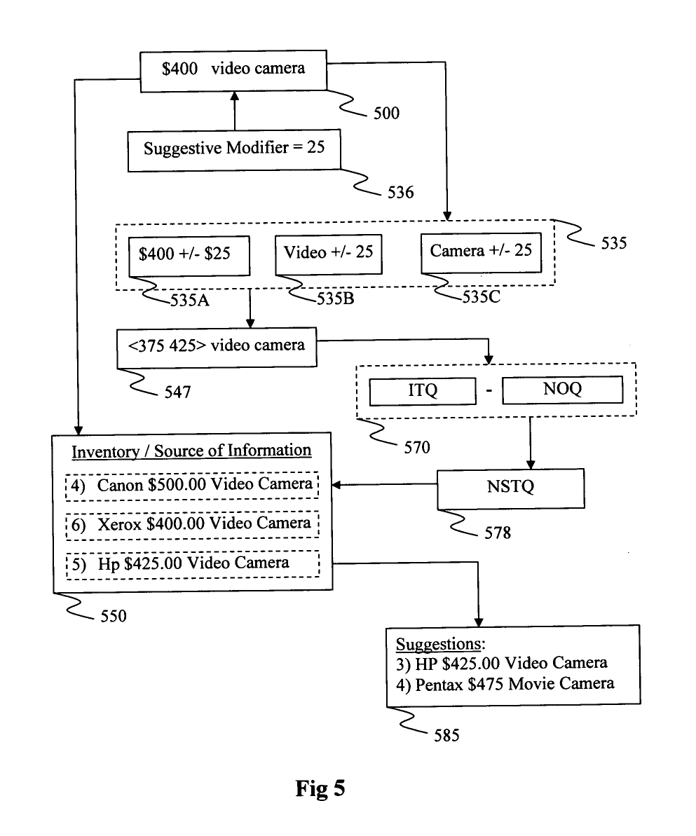

FIG. 5 is another non-limiting exemplary illustration of a slight variation of the inventive method implementing text-based technology. In this example, a suggestive value modifier affects every single text element and/or numeric element in the query. For example, the ITQ 500 (FIG. 5) is Mathematically Operate 535 (FIG. 5) with the Suggestive Modifier 536 (FIG. 5). Accordingly, every element of the ITQ query is numerically operated such as the First Element Operation 535A (FIG. 5) which involved adding and/or subtracting 25 from $400, the Second Element Operation 535B (FIG. 5) which involves adding and/or subtracting from the word “video,” and the Third Element Operation 535C (FIG. 5) which involves adding and/or subtracting from “camera.” Accordingly, only one element ($400) is affected, thus leading to the new Numerically Operated Query 547 (FIG. 5) or “NOQ” for short. In this example, the ITQ 500 (FIG. 5), and the NOQ 549 (FIG. 5) are subtracted 570 (FIG. 5), thus forming the New Suggestion Text Query 578 (FIG. 5) or NSTQ for short; which searches the SOI 550 (FIG. 5) thus forming the Suggestions Results Display 585 (FIG. 5).

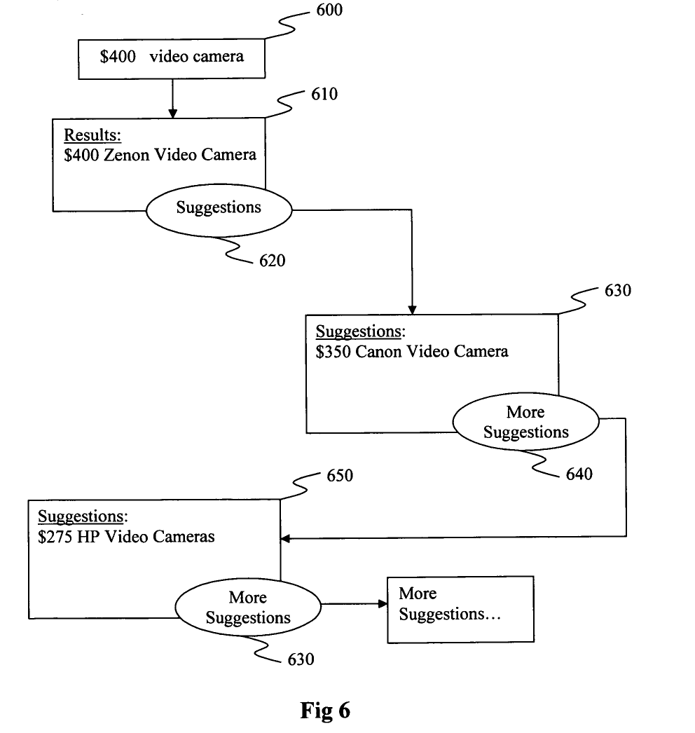

FIG. 6 is non-limiting exemplary illustration of a variation of the inventive method providing a series of echelon suggestions. For example, the Input Query 600 (FIG. 6) or “$400 video cameras” produces a First Display of Results 610 (FIG. 6) or “$400 Zenon Video camera.” Appropriately, a First Suggestions 620 (FIG. 6) link is displayed that when clicked, produces the First Suggestion Display 630 (FIG. 6) such as “$350 Canon video camera.” Accordingly, a Second SSI 640 (FIG. 6) is displayed that when clicked produces a Second Suggestion Display 650 (FIG. 6) such as “$275 HP video cameras” (less similar information) thus forming an echelon of suggesting information or hierarchical clusters with less similar data. Please note, whether results were found and/or retrieved, echelon suggesting results can appropriately produce an entire inventory in repetitive suggesting clusters.

The embodiments and/or enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

### CONCLUSION

From the foregoing, a series of novel methods for producing, displaying and suggesting search information can be appreciated. The described methods overcome the limitations encountered when querying information removes the possibility of retrieving similar and approximate results, while improving ecommerce applications.

1. A method for suggesting results comprising the steps of:
a) Identifying a first information value in a query; wherein said first information value includes at least one of a: value, and value range;
b) Performing a mathematical operation implementing said first information value such as adding, subtracting, multiplying, and dividing;
c) Identifying a second information value resulting from said mathematical operation; wherein said second information value includes at least one of a: value and value range;
d) Identifying a third information value in a corpus or information; wherein said third information value matches the said second information value;
e) Performing a suggesting action including at least one of a: displaying said third information value, suggesting said third information value, providing said third information value.
